(19) United States
(12) Patent Application Publication
(10) Pub. No.: US 2014/0377636 A1
(43) Pub. Date: Dec. 25, 2014

(54) ALUMINUM POUCH FILM FOR SECONDARY BATTERY, PACKAGING MATERIAL INCLUDING SAME, SECONDARY BATTERY INCLUDING SAME, AND METHOD FOR MANUFACTURING ALUMINUM POUCH FILM FOR SECONDARY BATTERY

(71) Applicant: HEESUNG CHEMICAL LTD., Chungcheongbuk-do (KR)

(72) Inventors: Mun-Yong Sung, Seoul (KR); Jun-Ho Shim, Seoul (KR); Jae-gu Kim, Chungcheongbuk-do (KR); Sung-Man Kim, Gyeonggi-do (KR)

(21) Appl. No.: 14/370,797

(22) PCT Filed: Jan. 8, 2013
(86) PCT No.: PCT/KR2013/000113

§ 371 Date: Jul. 7, 2014

(30) Foreign Application Priority Data
Jan. 9, 2012 (KR) 10-2012-0002426
Jan. 9, 2012 (KR) 10-2012-0002427

(51) Int. Cl. H01M 2/02

(52) U.S. Cl. CPC H01M 2/0267; H01M 2/0287; H01M 2/0285; H01M 2/026; H01M 2/0262
USPC 429/163; 156/244.17

(57) ABSTRACT

This invention relates to an aluminum pouch film for a secondary battery, including an aluminum layer; an outer layer formed on the first surface of the aluminum layer; a first adhesive layer for adhering the aluminum layer and the outer layer; an inner layer formed on the second surface of the aluminum layer and configured to include a crosslinked polymer layer; and a second adhesive layer for adhering the aluminum layer and the inner layer.

### TECHNICAL FIELD

The present invention relates to an aluminum pouch film for a secondary battery and a manufacturing method thereof, and more particularly, to an aluminum pouch film for a secondary battery, which is remarkably improved in moldability, electrical insulating properties and electrolyte resistance, compared to conventional exterior materials for secondary batteries, and to a method of manufacturing the same.

### BACKGROUND ART

A secondary battery typically refers to a lithium secondary battery, and is a battery including a polymer electrolyte and generating current through movement of lithium ions. Useful as an exterior material for packaging the secondary battery is a pouch for a secondary battery. The pouch for a secondary battery functions to protect a battery cell comprising an electrode assembly and an electrolyte which is introduced therein by the subsequent process. Furthermore, the pouch is configured to include an aluminum thin film to complement electrochemical properties of the battery cell and to impart heat dissipation properties. The aluminum thin film for protecting the battery cell from external impact includes, as an outer layer, a functional polymer film made of polyethylene terephthalate (PET), polyethylene naphthalate (PEN), a nylon resin or a liquid crystal polymer (LCP).

A pouch includes an upper pouch and a lower pouch which are bonded by thermal fusion along the outer circumference thereof, and an adhesive layer is formed between the lower surface of the upper pouch and the upper surface of the lower pouch so as to be adhered to each other using polyolefin such as polyethylene (PE), casted polypropylene (cPP) or polypropylene (PP) or copolymers thereof.

The upper pouch has a predetermined layered structure comprising an outer layer, an adhesive layer and an aluminum layer which are sequentially formed, and the lower pouch is configured to include an aluminum layer, an adhesive layer and an outer layer.

The pouch type secondary battery thus configured may be damaged due to various reasons in diverse processes. For example, in the course of placing the electrode assembly in the pouch, the PP or the cPP layer in the pouch may be cracked by a protrusion such as an electrode tap or an electrode lid, and the aluminum layer may be exposed due to such cracking

Also when the pouch is sealed, external heat is applied. Such heat may undesirably result in formation of fine pinholes or inner damage of the pouch, so that the inner adhesive layer may crack, and thus the aluminum layer may be exposed to the electrolyte.

In addition thereto, the adhesive layer in thin film form may be damaged by dropping, impact, pressure or compression, and the aluminum layer may be exposed to the electrolyte through the damaged portion of the adhesive layer.

The aluminum layer exposed to the electrolyte may corrode attributable to a chemical reaction between an electrolyte penetrated or diffused in the battery and oxygen or moisture, thereby generating corrosive gas, undesirably incurring swelling in the battery.

More specifically, LiPF₆ reacts with water and oxygen, thus producing corrosive gas, that is, hydrofluoric acid (HF). This hydrofluoric acid may react with aluminum to thus cause a drastic exothermic reaction. Also, when it is secondarily adsorbed to the surface of aluminum and penetrates into the structure, the brittleness of the structure may increase, and thereby the pouch film may be cracked by even a very small impact and the electrolyte may leak, thus causing a reaction between lithium and the atmosphere, undesirably resulting in ignition.

In order to prevent contact between such corrosive hydrofluoric acid and aluminum, various aluminum surface modification techniques are under study. With regard thereto, Korean Patent Application Publication No. 10-2006-0127031 discloses an aluminum surface modification technique, including low-temperature thermal treatment for maintaining an aluminum foil, firing treatment, sol-gel coating, primer treatment, corona, plasma treatment, etc.

However, with the recent trend of gradually increasing the capacity of a secondary battery, limitations are imposed on solving the above problems by only a surface modification of aluminum. Accordingly, there is a continuous need for an aluminum pouch film for a secondary battery, having outstanding heat resistance, chemical resistance and durability.

### DISCLOSURE

### Technical Problem

The present invention has been made keeping in mind the above problems, and an object of the present invention is to provide an aluminum pouch film for a secondary battery and a manufacturing method thereof, wherein even when the battery is exposed to external physical or chemical impact or stress, cracking of the adhesive layer in the pouch may be suppressed, and superior moldability, electrical insulating properties and electrolyte resistance may be exhibited.

### Technical Solution

The present invention provides an aluminum pouch film for a secondary battery, comprising an aluminum layer; an outer layer formed on the first surface of the aluminum layer; a first adhesive layer for adhering the aluminum layer and the outer layer; an inner layer formed on the second surface of the aluminum layer and configured to include a crosslinked polymer layer; and a second adhesive layer for adhering the aluminum layer and the inner layer.

In addition, the present invention provides a packaging material including the aluminum pouch film for a secondary battery.

In addition, the present invention provides a secondary battery including the aluminum pouch film for a secondary battery.

In addition, the present invention provides a method of manufacturing an aluminum pouch film for a secondary battery, comprising a) preparing an aluminum layer; b) forming an outer layer on the first surface of the aluminum layer; c) preparing an inner layer including a crosslinked polymer layer; and d) adhering the inner layer including the crosslinked polymer layer to the second surface of the aluminum layer.

In addition, the present invention provides a method of manufacturing an aluminum pouch film for a secondary battery, comprising a) preparing an aluminum layer; b) forming an outer layer on the first surface of the aluminum layer; c1) preparing a polymer containing a crosslinking agent and a polymer containing no crosslinking agent; c2) extruding the two kinds of polymers using a multi-die extrusion system, thus forming an inner layer; d) adhering the inner layer to the second surface of the aluminum layer, thus forming a film; and e) applying energy to the film formed in d).

### Advantageous Effects

According to the present invention, an aluminum pouch film for a secondary battery is remarkably improved in moldability, electrical insulating properties and electrolyte resistance. Hence, even when it is exposed to physical or chemical impact or stress, cracking of the adhesive layer in the pouch can be suppressed, and also the chemical reaction between the aluminum layer and the electrolyte can be prevented from occurring, thereby reducing the risk of explosion due to high temperature or the swelling in the battery by the gas generated therein.

### DESCRIPTION OF DRAWINGS

FIG. 1 is a view illustrating the structure of an aluminum pouch film for a secondary battery; and

FIG. 2 is a graph illustrating the results of evaluation of heat resistance of Example 1 according to the present invention and Comparative Example 1.

### BEST MODE

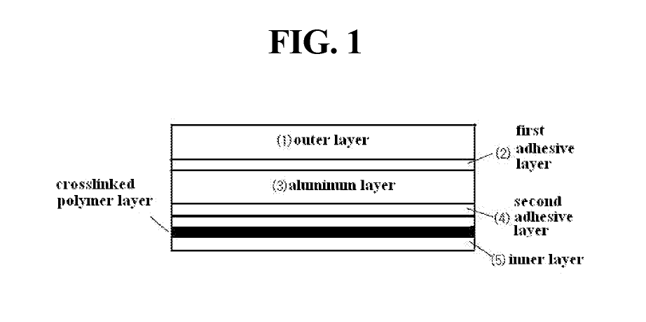

According to the present invention, an aluminum pouch film for a secondary battery comprises, as illustrated in FIG. 1, an aluminum layer 3; an outer layer 1 formed on the first surface of the aluminum layer; a first adhesive layer 2 for adhering the aluminum layer and the outer layer; an inner layer 5 formed on the second surface of the aluminum layer and configured to include a crosslinked polymer layer; and a second adhesive layer 4 for adhering the aluminum layer and the inner layer.

Hereinafter, a detailed description will be given of respective layers of the aluminum pouch film for a secondary battery according to the present invention.

Aluminum Layer

In the aluminum pouch film for a secondary battery according to the present invention, the aluminum layer preferably includes a soft aluminum foil, and more preferably an iron-containing aluminum foil to impart pinhole resistance and ductility upon cold molding. As for the iron-containing aluminum foil, iron is used in an amount of preferably 0.1˜9.0 mass %, and more preferably 0.5˜2.0 mass %, based on 100 mass % of the aluminum foil. If the amount of iron is less than 0.1 mass % based on 100 mass % of the aluminum foil, ductility of the aluminum layer may decrease. In contrast, if the amount thereof exceeds 9.0 mass %, moldability may decrease.

The thickness of the aluminum layer is preferably set to 10˜100 μm, and more preferably 30˜50 μm, taking into consideration pinhole resistance, processability, and oxygen and moisture barrier properties. If the thickness thereof is less than 10 μm, the resulting layer may be easily torn, and electrolyte resistance and electrical insulating properties may deteriorate. In contrast, if the thickness thereof exceeds 100 μm, moldability may become poor.

### Outer Layer

In the aluminum pouch film for a secondary battery according to the present invention, because the outer layer corresponds to a portion which comes into direct contact with hardware, it is preferably made of an insulating resin. The resin for use in the outer layer may include a polyester resin such as polyethylene terephthalate, polybutylene terephthalate, polyethylene naphthalate, polybutylene naphthalate, co-polyester or polycarbonate, or a nylon film. Particularly useful is a nylon film. The nylon film has excellent rupture strength, pinhole resistance and gas barrier properties and is also superior in heat resistance, cold resistance and mechanical strength, and is thus mainly utilized as a packaging film. Specific examples of the nylon film may include polyamide resin such as Nylon 6, Nylon 66, a copolymer of Nylon 6 and Nylon 66, Nylon 610, and poly(m-xylene adipamide) (MXD6).

The thickness of the stacked outer layer is preferably at least 10˜30 μm, and particularly 12˜25 μm. If the thickness thereof is less than 10 μm, physical properties may deteriorate and the resulting layer may be easily torn. In contrast, if the thickness thereof exceeds 30 μm, moldability may decrease.

Stacking the outer layer is not particularly limited, but is preferably performed using a lamination process such as dry lamination or extrusion lamination.

First Adhesive Layer

In the aluminum pouch film for a secondary battery according to the present invention, the first adhesive layer is made of a polyurethane-based adhesive composed mainly of a polyol component and further comprising an isocyanate compound or derivatives thereof as a curing agent.

The first adhesive layer preferably has a thickness of 2˜10 μm, and more preferably 3˜5 μm, taking account of adhesion to the outer layer and the thickness after a molding process. If the thickness thereof is less than 2 μm, adhesion may decrease. In contrast, if the thickness thereof exceeds 10 μm, cracking may occur.

Inner Layer

In the aluminum pouch film for a secondary battery according to the present invention, the inner layer may include polyolefin such as polyethylene (PE) or polypropylene (PP), or copolymers thereof. When the polymer layer is made of polyolefin such as PE or PP or copolymers thereof, properties such as good heat sealing capability, moisture resistance or heat resistance, required of a packaging material for a secondary battery, may be exhibited, and good lamination processability may result.

The thickness of the polymer layer of the inner layer is preferably set to 20˜60 μm and more preferably 30˜50 μm in consideration of moldability, electrical insulating properties and electrolyte resistance. When the thickness thereof falls out of the above range, moldability, electrical insulating properties and electrolyte resistance may deteriorate.

The inner layer includes a crosslinked polymer layer. The crosslinked polymer layer is preferably disposed at the middle portion of the inner layer, and non-crosslinked polymer layers may be disposed at both sides of the crosslinked polymer layer. When the crosslinked polymer layer is provided, properties such as heat resistance and electrolyte resistance may be improved. The thickness of the crosslinked polymer layer is preferably set to ⅓˜½ of the total thickness of the inner layer. If the thickness of the crosslinked polymer layer is less than the above lower limit, heat resistance and electrolyte resistance may become poor. In contrast, if the thickness thereof is greater than the above upper limit, moldability may deteriorate.

The inner layer including the crosslinked polymer layer may be prepared by extruding a polymer containing a crosslinking agent and a polymer containing no crosslinking agent using a multi-die extrusion system, and then applying energy to the extruded inner layer. In the polymer containing the crosslinking agent, the crosslinking agent is not particularly limited but preferably includes a peroxide-based crosslinking agent. Also, the crosslinking agent is preferably used in an amount of 1˜3 wt % based on the total weight of the mixed polymer. If the amount of the crosslinking agent is less than 1 wt %, crosslinking does not occur well. In contrast, if the amount thereof exceeds 3 wt %, there is no effect due to the further increase of the crosslinking agent.

Applying the energy may be implemented using an irradiation process with γ-ray, ε-beam or UV beam.

Second Adhesive Layer

In the aluminum pouch film for a secondary battery according to the present invention, the second adhesive layer may be made of polyurethane, an acid-modified polyolefin resin or epoxy. A specific example of the second adhesive may include maleic anhydride polypropylene (MAH PP).

The thickness of the second adhesive layer is preferably set to 2˜30 μm, and more preferably 3˜15 μm, taking into consideration the adhesion to the inner layer and the thickness after a molding process. If the thickness thereof is less than 2 μm, adhesion may become weak. In contrast, if the thickness thereof exceeds 30 μm, cracking may occur.

Stacking the inner layer and the aluminum layer on both sides of the second adhesive layer is not particularly limited, but may be executed using a lamination process, such as dry lamination or extrusion lamination.

In addition, the aluminum pouch film according to the present invention may be manufactured by a) preparing an aluminum layer; b) forming an outer layer on the first surface of the aluminum layer; c) preparing an inner layer including a crosslinked polymer layer; and d) adhering the inner layer including the crosslinked polymer layer to the second surface of the aluminum layer.

In addition, the present invention addresses a packaging material, comprising the aluminum pouch film for a secondary battery.

In addition, the present invention addresses a secondary battery, comprising the aluminum pouch film for a secondary battery.

In addition, the present invention addresses a method of manufacturing the aluminum pouch film for a secondary battery. The method of manufacturing the aluminum pouch film comprises a) preparing an aluminum layer; b) forming an outer layer on the first surface of the aluminum layer; c) preparing an inner layer including a crosslinked polymer layer; and d) adhering the inner layer including the crosslinked polymer layer to the second surface of the aluminum layer. Below is a detailed description of the manufacturing method as above.

a) Preparing Aluminum Layer

Useful for the aluminum layer, an aluminum foil may be an untreated aluminum foil, but is preferably an aluminum foil subjected to degreasing treatment to impart electrolysis resistance and electrolyte resistance. Degreasing treatment may be carried out using a wet type process or a dry type process.

Examples of the wet type degreasing treatment may include acid degreasing and alkaline degreasing. The acid for use in acid degreasing may be exemplified by an inorganic acid such as sulfuric acid, acetic acid, phosphoric acid and fluoric acid, which may be used alone or in combination of two or more. Furthermore, in order to enhance the etching effect of the aluminum foil, a variety of metal salts may be added, as necessary. The alkali for alkaline degreasing may include for example a strong alkali such as sodium hydroxide, or a mixture thereof with a weak alkali or a surfactant.

An example of the dry type degreasing treatment may include annealing of aluminum at high temperature.

b) Forming Outer Layer on First Surface of Aluminum Layer

Upon forming an outer layer on the first surface of the aluminum layer in the aluminum pouch film for a secondary battery according to the present invention, a first adhesive layer is applied on the aluminum layer prepared in a). As such, the thickness of the first adhesive layer is preferably set to 2˜10 μm, and more preferably 3˜μm, in consideration of the adhesion to the outer layer and the thickness after a molding process. If the thickness thereof is less than 2 μm, adhesion may decrease. In contrast, if the thickness thereof exceeds 10 μm, cracking may occur.

The outer layer is stacked on the applied first adhesive layer using a lamination process such as dry lamination or extrusion lamination, thus forming the outer layer. Because the outer layer corresponds to a portion which comes into direct contact with hardware, it is preferably made of an insulating resin. The resin for use in the outer layer preferably includes a polyester resin, such as polyethylene terephthalate, polybutylene terephthalate, polyethylene naphthalate, polybutylene naphthalate, co-polyester or polycarbonate, or a nylon film. Particularly useful is a nylon film. The nylon film has excellent rupture strength, pinhole resistance and gas barrier properties and is also superior in heat resistance, cold resistance and mechanical strength, and is thus mainly utilized as a packaging film. Specific examples of the nylon film may include polyamide resin such as Nylon 6, Nylon 66, a copolymer of Nylon 6 and Nylon 66, Nylon 610, and poly(m-xylene adipamide) (MXD6).

Stacking the outer layer is not particularly limited, but may be executed using a lamination process such as dry lamination or extrusion lamination.

c) Preparing Inner Layer Including Crosslinked Polymer Layer

Upon preparing an inner layer including a crosslinked polymer layer in the aluminum pouch film for a secondary battery according to the present invention, a polymer containing a crosslinking agent and a polymer containing no crosslinking agent are prepared (Step c1)). The polymer useful in the present invention may include polyolefin such as PE or PP, or copolymers thereof. When the polymer layer is made of polyolefin such as PE or PP or copolymers thereof, properties such as good heat sealing capability, moisture resistance or heat resistance, required of a packaging material for a secondary battery, may be exhibited, and good lamination processability may result. Also, the crosslinking agent is not particularly limited but may include a peroxide-based crosslinking agent. The crosslinking agent is preferably used in an amount of 1˜3 wt % based on the total weight of the mixed polymer. If the amount of the crosslinking agent is less than 1 wt %, crosslinking does not occur well. In contrast, if the amount thereof exceeds 3 wt %, there is no effect due to the further increase of the crosslinking agent.

Thereafter, the polymer containing the crosslinking agent and the polymer containing no crosslinking agent are extruded using a multi-die extrusion system, thus forming an inner layer (Step c2)). As such, the multi-die extrusion system enables the polymer and the polymer containing the crosslinking agent to be separately extruded using a die including only a polymer and a die including a polymer containing a crosslinking agent, respectively. The films extruded from respective dies are controlled such that the polymer containing the crosslinking agent is located at the middle position of the polymer layers, thereby forming the inner layer. The thickness of the crosslinked polymer layer is preferably set to ⅓˜½ of the total thickness of the inner layer. If the thickness of the crosslinked polymer layer is less than the above lower limit, heat resistance and electrolyte resistance may deteriorate. In contrast, if the thickness thereof is greater than the above upper limit, moldability may decrease.

Subsequently, energy is applied to the inner layer formed in c2) (Step c3)).

After formation of the inner layer configured such that the polymer containing the crosslinking agent is located at the middle position of the polymer layers by the extrusion in c2), energy such as γ-ray, ε-beam or UV beam is applied, and thereby the crosslinking agent is crosslinked with the polymer, thus forming the crosslinked portion in the inner layer.

Alternatively, c3) applying energy may be performed after d) adhering the crosslinked inner layer as will be described below. As such, because the aluminum pouch film is molded in the form of a pouch and then energy is applied thereto, moldability of the aluminum pouch film may be further improved.

d) Adhering Inner Layer to Second Surface of Aluminum Layer

Upon adhering the inner layer including the crosslinked polymer layer to the second surface of the aluminum layer in the aluminum pouch film for a secondary battery according to the present invention, a second adhesive layer for adhering the aluminum layer and the inner layer may be made of polyurethane, an acid-modified polyolefin resin or epoxy, and a specific example thereof may include maleic anhydride polypropylene (MAH PP).

The thickness of the second adhesive layer is preferably set to 2˜30 μm, and more preferably 3˜15 μm, taking into consideration the adhesion to the inner layer and the thickness after a molding process. If the thickness thereof is less than 2 μm, adhesion may become weak. In contrast, if the thickness thereof exceeds 30 μm, cracking may occur.

Stacking the inner layer on the aluminum layer is not particularly limited, but may be conducted using a lamination process, such as dry lamination or extrusion lamination.

### Mode for Invention

A better understanding of the present invention may be obtained through the following examples and test examples which are set forth to illustrate, but are not to be construed as limiting the present invention.

EXAMPLE 1 AND COMPARATIVE EXAMPLE 1

### Manufacture of Aluminum Pouch Film for Secondary Battery

The aluminum pouch film for a secondary battery according to the present invention is more specifically described by the following.

### Example 1

An aluminum foil (available from Dong-Il Aluminum) having an area of 30 cm×20 cm and a thickness of 40 μm was immersed in a 5% sulfuric acid solution so as to be acid-degreased, and then immersed in a 5% sodium hydroxide solution so that the surface thereof was activated. Thereafter, a polyurethane adhesive resin (available from Hi-Chem) having a thickness of 4 μm was applied, and Nylon 6 (available from Hyosung) having a thickness of 25 μm was subjected to dry lamination, so that nylon was stacked on the aluminum layer.

Also, a polymer comprising polypropylene (available from Honam Petrochemical) and a peroxide-based crosslinking agent (available from Ciba-Geigy) mixed at a weight ratio of 98:2 and a polymer composed exclusively of polypropylene (available from Honam Petrochemical) were subjected to multi-die extrusion, and thereby polymer layers composed exclusively of polypropylene were extruded to a thickness of 10 μm from two dies, and a polymer layer comprising polypropylene and the peroxide-based crosslinking agent was extruded to a thickness of 15 μm from the other die, after which these polymer layers were stacked such that the polymer layer comprising polypropylene and the crosslinking agent was interposed between the two polymer layers composed exclusively of polypropylene, thus forming an inner layer. Then, the inner layer was irradiated with UV beam and thus crosslinked.

Thereafter, maleic anhydride polypropylene (available from Hi-Chem) having a thickness of 10 μm was applied on the surface of the aluminum layer opposite the surface on which nylon was applied, and then the crosslinked inner layer was subjected to dry lamination, thereby manufacturing an aluminum pouch film.

### Comparative Example 1

An aluminum pouch film was manufactured in the same manner as in Example 1, with the exception that UV beam was applied to the stacked polymer layers.

Evaluation of Electrolyte Resistance

Specimens obtained by cutting the aluminum pouch films of Example 1 and Comparative Example 1 to 2 cm×4 cm were placed together with an LiPF₆ electrolyte (available from Leechem) in a testing reactor, sealed and then heated to 85° C. Each film was observed with the naked eye for film separation at intervals of 4 hr for 24 hr to evaluate electrolyte resistance. The results are given in Table 1 below.

TABLE 1

| | 4 hr | 8 hr | 12 hr | 16 hr | 20 hr | 24 hr |
|---|---|---|---|---|---|---|
| Comp. Ex. 1 | ◯ | Δ | Δ | X | X | X |
| Ex. 1 | ◯ | ◯ | ◯ | ◯ | ◯ | ◯ |

◯: No separation
Δ: Partial separation
X: Separation

Evaluation of Electrical Insulating Properties

Each of the aluminum pouch films of Example 1 and Comparative Example 1 was molded to 3 cm×5 cm×0.62 cm (width×length×thickness), filled with an electrode assembly comprising a cathode, a separator and an anode, and an LiPF₆ electrolyte (available from Leechem), sealed and stored at 85° C. for 24 hr, after which the electrode and the upper aluminum layer were intentionally exposed, and whether they were electrically insulated (1 MΩ or more) was measured. The results are given in Table 2 below.

TABLE 2

| | Electrical Insulation |
|---|---|
| Comp. Ex. 1 | ≦1 MΩ |
| Ex. 1 | ≧1 MΩ |

Evaluation of Heat Resistance

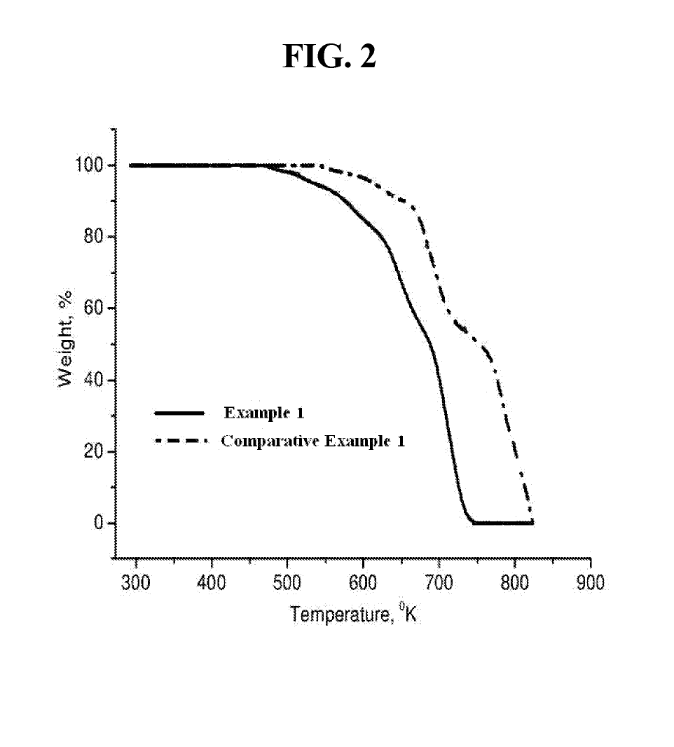

In order to evaluate heat resistance of the pouch film, the inner layer films of Example 1 and Comparative Example 1 were measured for changes in film weight while increasing the temperature from room temperature to approximately 500° C. at a predetermined heating rate (20° C./min) using thermal gravimetric analysis. The results are shown in FIG. 2.

As is apparent from the results of the weight reduction of the polyolefin film for the inner layer depending on the temperature, upon evaluation based on the temperature when the weight was reduced by 10% than the initial weight, the 10% change occurred at approximately 300° C. in Comparative Example 1 and at approximately 376° C. in Example 1, which means that heat resistance was increased by approximately 25%.

1. An aluminum pouch film for a secondary battery, comprising:
an aluminum layer;
an outer layer formed on a first surface of the aluminum layer;
a first adhesive layer for adhering the aluminum layer and the outer layer;
an inner layer formed on a second surface of the aluminum layer and configured to include a crosslinked polymer layer; and
a second adhesive layer for adhering the aluminum layer and the inner layer.

2. The aluminum pouch film of claim 1, wherein the crosslinked polymer layer is disposed at a middle portion of the inner layer.

3. The aluminum pouch film of claim 2, wherein a thickness of the crosslinked polymer layer is ⅓˜½ of a total thickness of the inner layer.

4. The aluminum pouch film of claim 1, wherein the outer layer is selected from the group consisting of polyethylene terephthalate, polybutylene terephthalate, polyethylene naphthalate, polybutylene naphthalate, co-polyester, polycarbonate, and a nylon film.

5. The aluminum pouch film of claim 1, wherein the inner layer is formed from a polyolefin or a polyolefin copolymer

6. The aluminum pouch film of claim 5, wherein the polyolefin comprises polyethylene (PE) or polypropylene (PP).

7. The aluminum pouch film of claim 1, wherein the first adhesive layer comprises a polyurethane-based adhesive.

8. The aluminum pouch film of claim 1, wherein the second adhesive layer is selected from the group consisting of polyurethane, an acid-modified polyolefin resin and epoxy.

9. The aluminum pouch film of claim 8, wherein the acid-modified polyolefin resin comprises maleic anhydride polypropylene (MAH PP).

10. A packaging material, comprising the aluminum pouch film of claim 1.

11. A secondary battery, comprising the aluminum pouch film of claim 1.

12. A method of manufacturing an aluminum pouch film for a secondary battery, comprising:
a) preparing an aluminum layer;
b) forming an outer layer on a first surface of the aluminum layer;
c) preparing an inner layer including a cross linked polymer layer; and
d) adhering the inner layer including the cross linked polymer layer to a second surface of the aluminum layer.

13. The method of claim 12, wherein c) preparing the inner layer comprises:
c1) preparing a polymer containing a crosslinking agent and a polymer containing no crosslinking agent;
c2) extruding the polymer containing the crosslinking agent and the polymer containing no crosslinking agent using a multi-die extrusion system, thus forming an inner layer; and
c3) applying energy to the extruded inner layer.

14. A method of manufacturing an aluminum pouch film for a secondary battery, comprising:
a) preparing an aluminum layer;
b) forming an outer layer on a first surface of the aluminum layer;
c1) preparing a polymer containing a crosslinking agent and a polymer containing no crosslinking agent;
c2) extruding the polymer containing the crosslinking agent and the polymer containing no crosslinking agent using a multi-die extrusion system, thus forming an inner layer; and
d) adhering the inner layer to a second surface of the aluminum layer, thus forming a film; and
e) applying energy to the film formed in d).
